(19) United States
(12) Patent Application Publication
(10) Pub. No.: US 2025/0142237 A1
(43) Pub. Date: May 1, 2025

(54) SYSTEMS AND METHODS FOR COHERENT PASSIVE OPTICAL NETWORKS

(71) Applicant: CABLE TELEVISION LABORATORIES, INC., Louisville, CO (US)

(72) Inventors: HAIPENG ZHANG, Broomfield, CO (US); ZHENSHENG JIA, Superior, CO (US)

(21) Appl. No.: 18/932,344

(22) Filed: Oct. 30, 2024

Related U.S. Application Data
(60) Provisional application No. 63/546,313, filed on Oct. 30, 2023.

(51) Int. Cl. H04Q 11/00; H04B 10/516; H04J 14/08

(52) U.S. Cl. CPC H04Q 11/0067; H04B 10/5161; H04J 14/08; H04Q 2011/0088

(57) ABSTRACT

An optical network communication system utilizes a CPON. The system includes an OLT and an ONU. The OLT includes an OLT transmitter for transmitting a downstream signal, and an OLT receiver for detecting an upstream signal. The downstream signal includes a first tone centered at a first frequency, a second tone centered at a second frequency, and first and second downstream subcarriers distributed proximate the first frequency. The upstream optical signal includes first and second upstream subcarriers distributed proximate the second frequency. The ONU includes an ONU receiver for detecting the first and second downstream subcarriers using the first optical tone to generate an LO signal for coherent detection, and an ONU transmitter configured to generate the first and second upstream subcarriers using the second optical tone. The first and second tones, downstream subcarriers, and upstream subcarriers do not overlap in the frequency domain

### CROSS REFERENCE TO RELATED APPLICATIONS

This application claims the benefit of and priority to U.S. Provisional Patent Application Ser. No. 63/546,313, filed Oct. 30, 2023, which is incorporated herein by reference in its entirety.

### BACKGROUND

The field of the disclosure relates generally to communication networks, and more particularly, coherent passive optical networks capable of time and frequency division multiplexing (TFDM).

Conventional access networks are progressing towards improved capabilities to handle increasingly heavy data streams with greater reach and penetration to end-users. At present, the passive optical network (PON) dominates the short-reach access market due to its efficient resource sharing, and is often implemented for point-to-multipoint (P2MP) deployment.

Conventional PON technology has focused primarily on intensity modulation-direct detection (IM-DD) schemes; however, IM-DD technology has been limited by a number of challenges preventing the adoption of 100 Gb/s (100G) and higher capacities. Coherent technology, on the other hand, has been shown to achieve higher capacities than IM-DD technology, and also with significantly improved receiver sensitivity. Recent coherent PON (CPON) advancements utilize time and frequency division multiplexing (TFDM) to provide flexibility for next-generation (NG) access networks by leveraging time and frequency domain bandwidth sharing techniques. In terms of flexibility and simplicity, TFDM offers advantages over conventional PON technologies, such as time division multiplexing (TDM) and wavelength division multiplexing (WDM), and without requiring multiple wavelengths and colored optics.

Access networks though, have been slow to adopt such advantageous CPON solutions due to the relatively higher component costs associated with conventional coherent optics technologies, which may be significant for customer premise equipment or devices (CPEs) at a user location. Conventional CPONs, for example, typically require high-quality optical sources, such as external cavity lasers (ECLs). Use of multiple ECLs, though, has tended to be cost-prohibitive for P2MP architectures that may have one central optical transceiver (e.g., an Optical Line Terminal (OLT)) servicing up to 400 or more remote optical transceivers (e.g., Optical Network Units (ONUs)). Recent innovations implement optical injection locking (OIL) techniques using relatively inexpensive Fabry-Perot laser diodes (FP-LDs) for a more cost-effective CPON. Nevertheless, the optical parent tone used by some conventional CPONs for OIL may overlap with downstream coherent signals, and thus result in signal transmission errors, particularly when OIL is implemented for a single-fiber architectural configuration.

Accordingly, there is a desire in the industry for cost-effective CPONs that do not experience the transmission errors seen in conventional OIL-based CPONs.

### BRIEF SUMMARY

In an embodiment, an optical network communication system utilizes a coherent passive optical network (CPON). The system includes an optical line terminal (OLT). The OLT includes an OLT transmitter configured to transmit a downstream optical signal and an OLT receiver configured to detect an upstream optical signal. The downstream optical signal includes a first optical tone centered at a first frequency, a second optical tone centered at a second frequency different from the first frequency, and first and second downstream subcarriers distributed proximate the first frequency. The upstream optical signal includes first and second upstream subcarriers distributed proximate the second frequency. The system further includes an optical distribution network (ODN) in operable communication with the OLT and configured to transport the downstream and upstream optical signals therethrough. The system further includes a first optical network unit (ONU) in operable communication with the ODN. The first ONU includes a first ONU receiver configured to detect the first and second downstream subcarriers using the first optical tone to generate a local oscillator (LO) signal for coherent detection, and a first ONU transmitter configured to generate the first and second upstream subcarriers using the second optical tone. The first and second optical tones, the first and second downstream subcarriers, and the first and second upstream subcarriers do not overlap in the frequency domain.

### BRIEF DESCRIPTION

These and other features, aspects, and advantages of the present disclosure will become better understood when the following detailed description is read with reference to the accompanying drawings in which like characters represent like parts throughout the drawings, wherein:

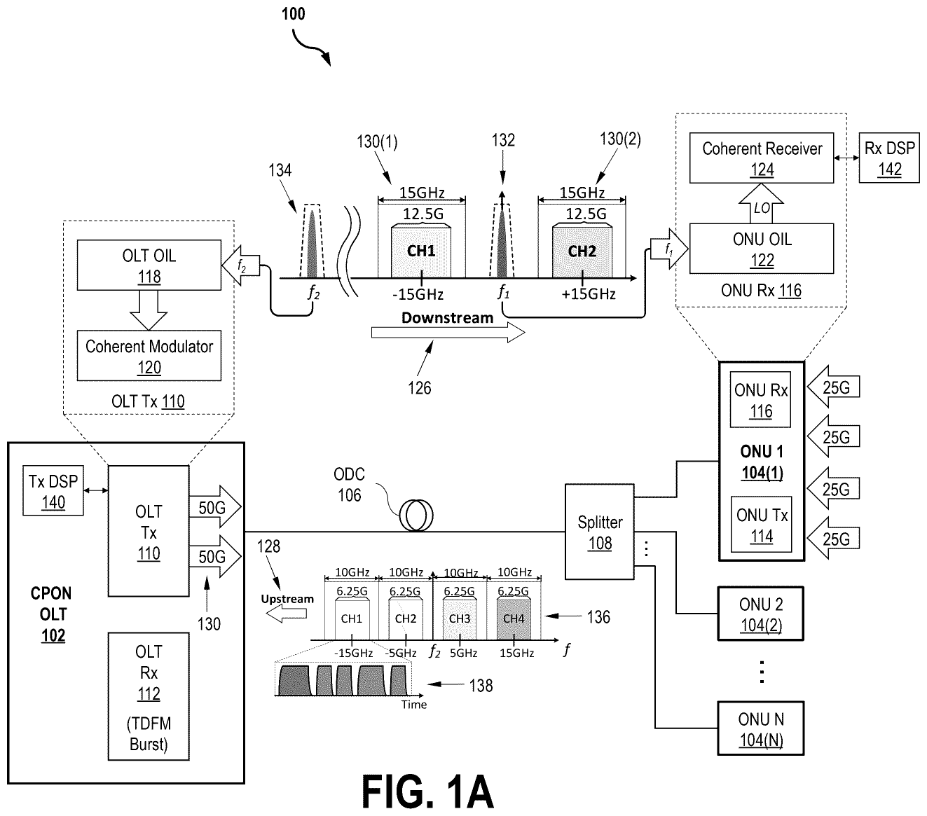

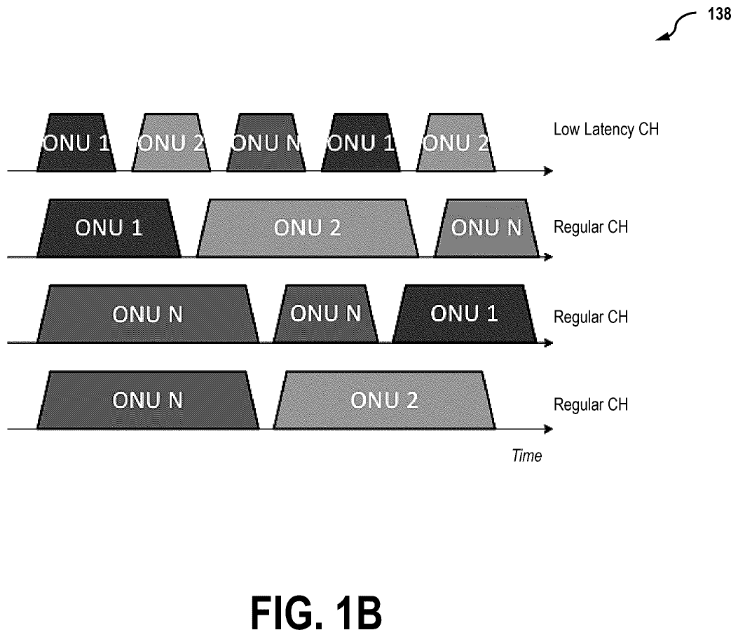

FIG. 1A is a schematic illustration depicting an exemplary coherent passive optical network architecture.

FIG. 1B is a schematic illustration depicting an exemplary subcarrier distribution scheme for the upstream burst distribution depicted in FIG. 1A.

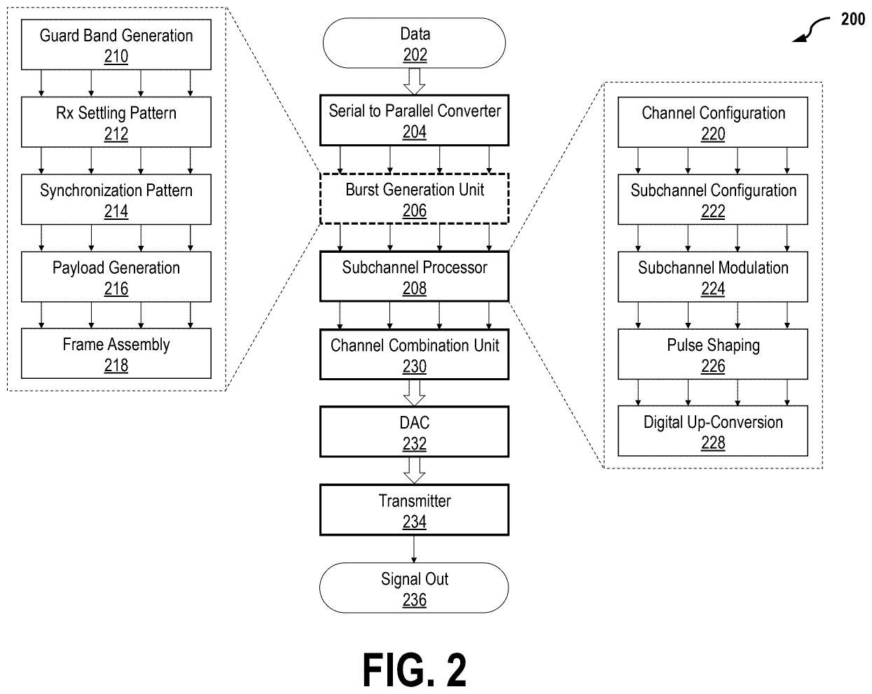

FIG. 2 is a schematic illustration depicting an exemplary logical transmission processing architecture.

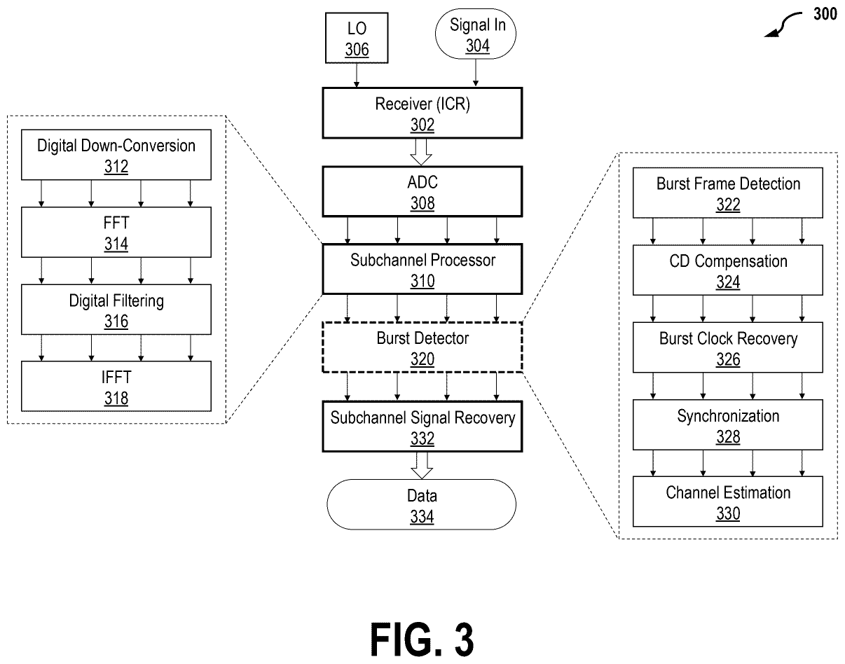

FIG. 3 is a schematic illustration depicting an exemplary logical reception processing architecture.

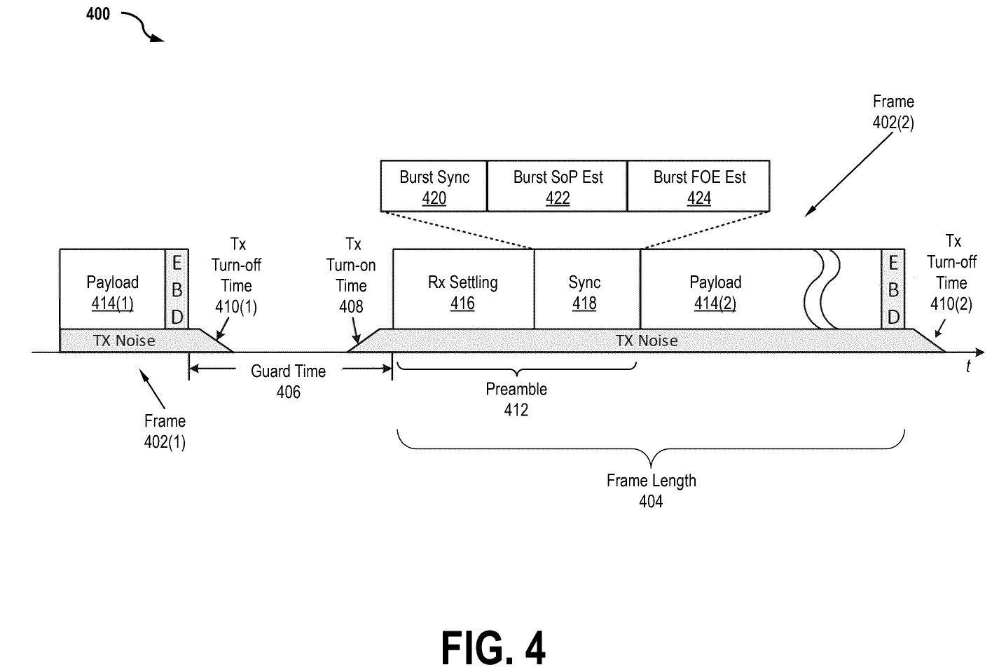

FIG. 4 is a schematic illustration depicting an exemplary coherent burst frame logical architecture.

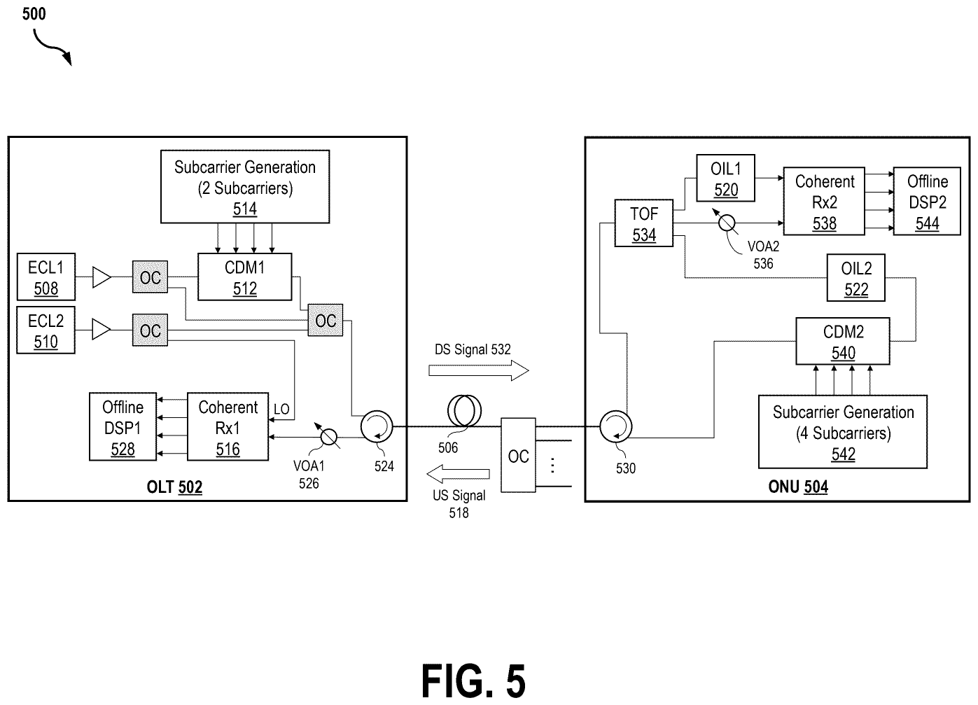

FIG. 5 is a schematic illustration of an exemplary test architecture for verifying experimental results of the embodiments herein.

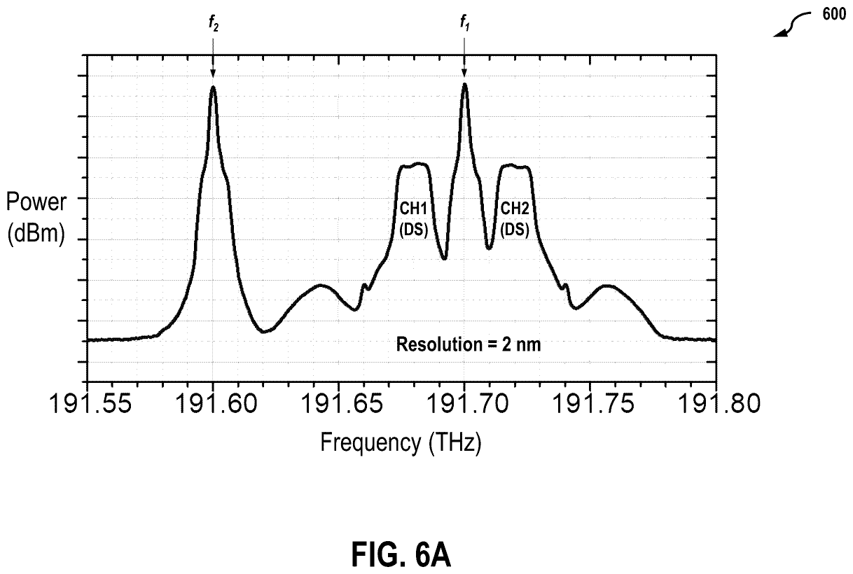

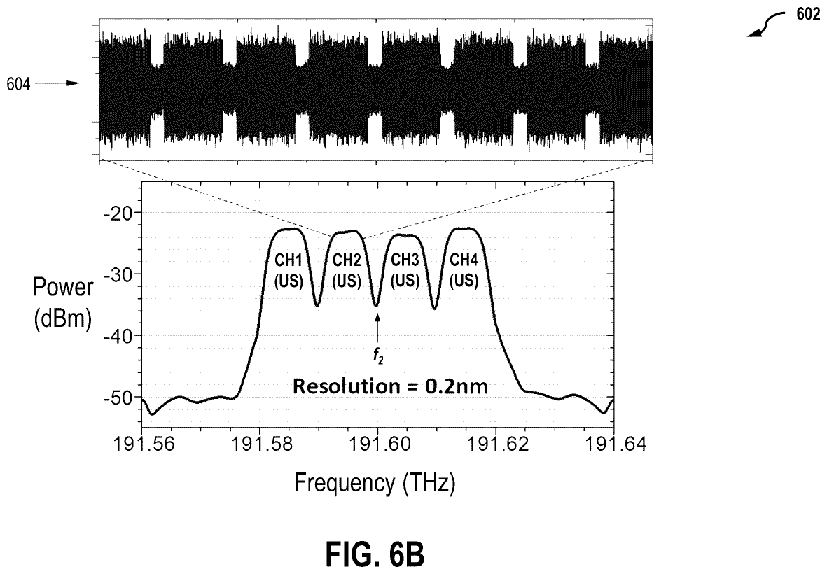

FIG. 6A is a graphical illustration depicting an optical spectrum plot of the downstream signal for the test architecture depicted in FIG. 5.

FIG. 6B is a graphical illustration depicting an optical spectrum plot of the upstream signal depicted in FIG. 5.

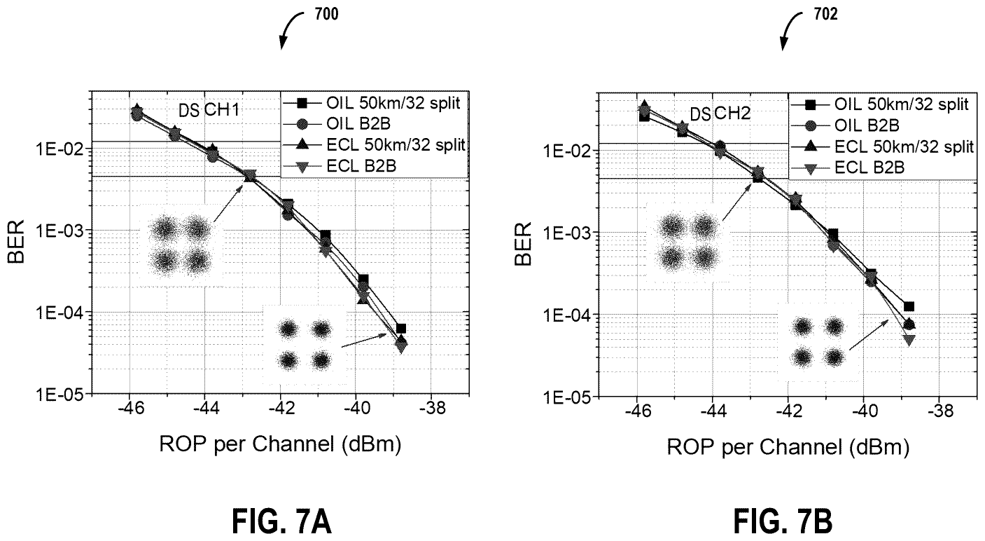

FIGS. 7A-B are graphical illustrations depicting measurement result plots obtained for the downstream signal depicted in FIG. 6A.

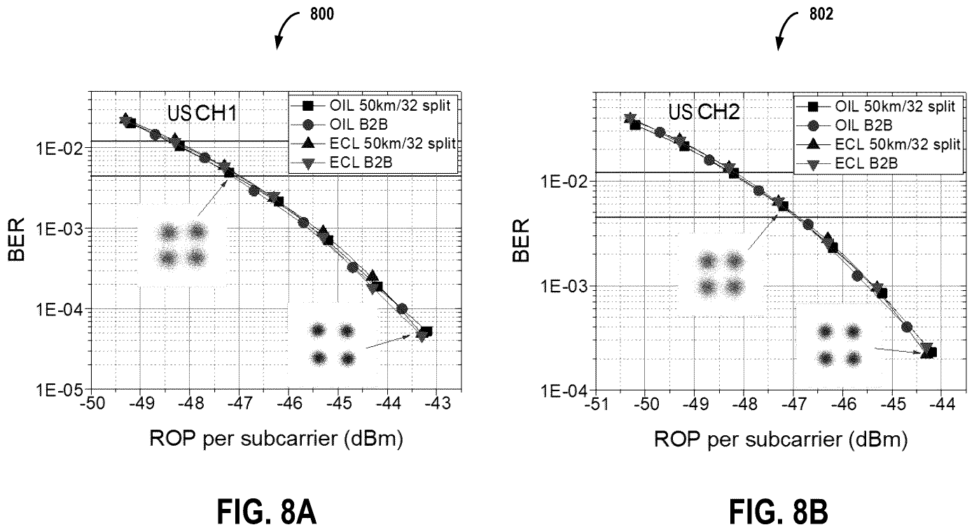

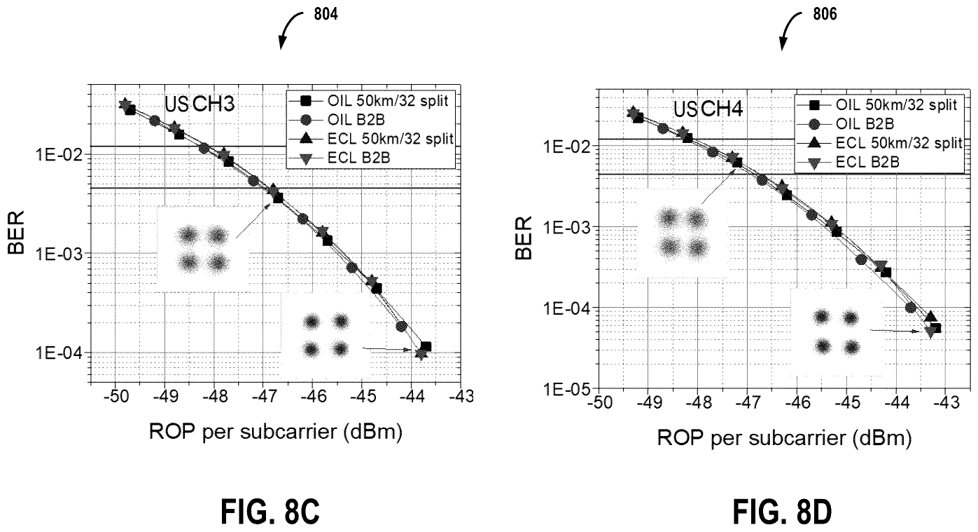

FIGS. 8A-D are graphical illustrations depicting measurement result plots obtained for the upstream signal depicted in FIG. 6B.

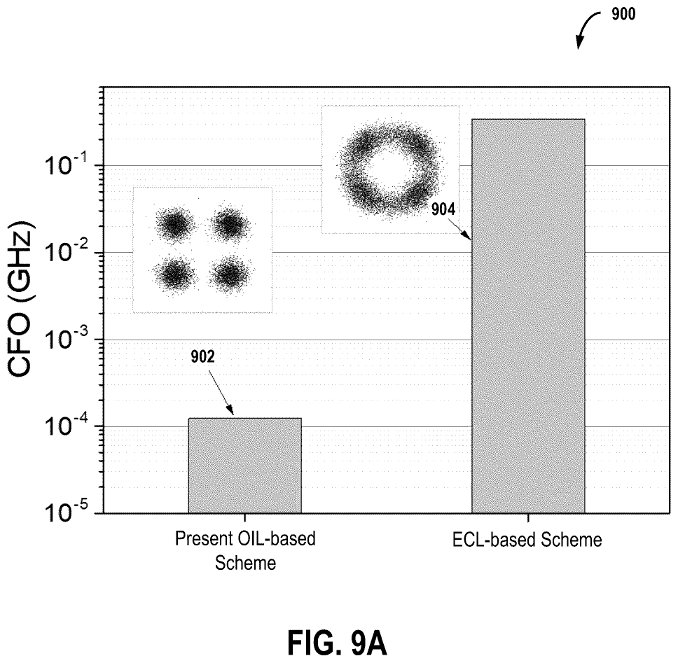

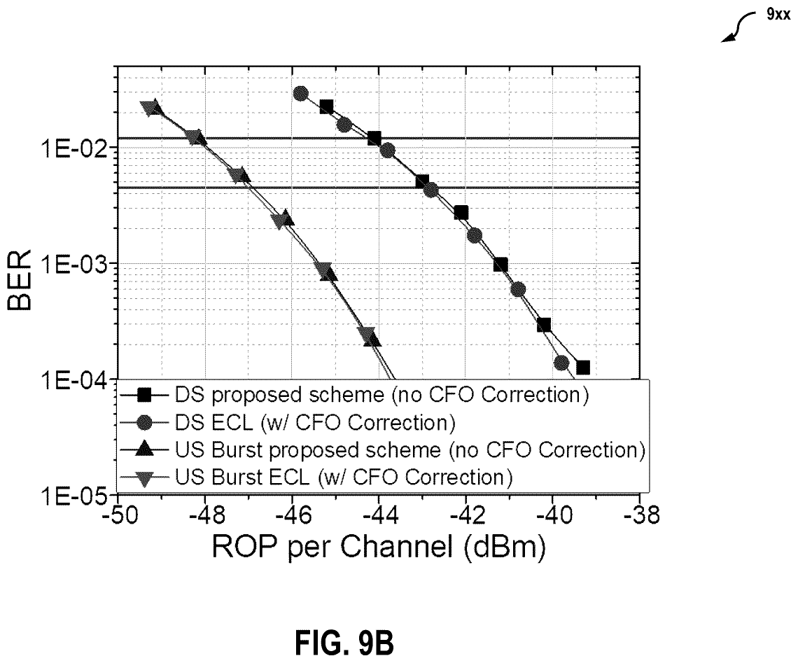

FIG. 9A is a graphical illustration depicting a comparative plot of residual carrier frequency offset.

FIG. 9B is a graphical illustration depicting a comparative plot of bit error rate versus received optical power in consideration of carrier frequency offset.

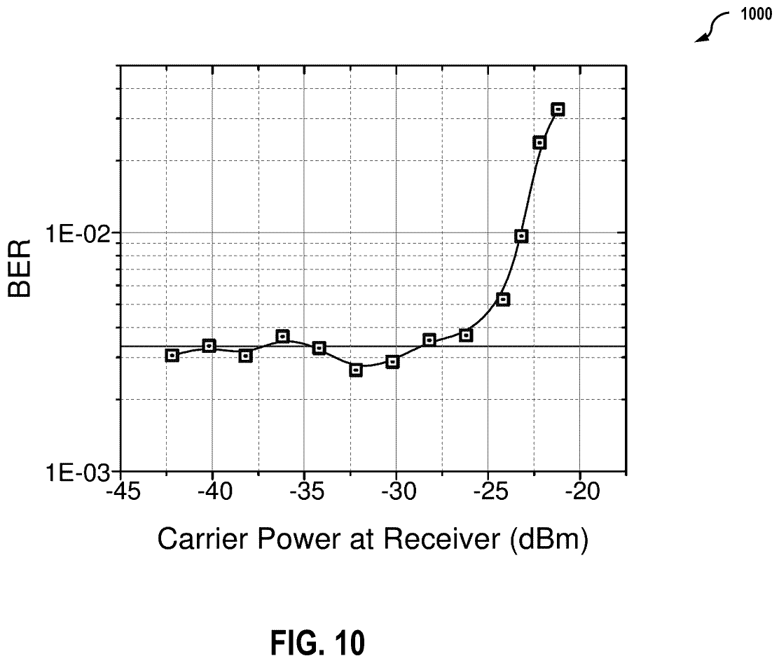

FIG. 10 is a graphical illustration depicting a measurement plot of bit error rate versus carrier power at a receiver.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events occur substantially instantaneously.

As used herein, “modem termination system” (MTS) refers to a termination unit including one or more of an Optical Network Terminal (ONT), an optical line termination (OLT), a network termination unit, a satellite termination unit, a cable modem termination system (CMTS), and/or other termination systems which may be individually or collectively referred to as an MTS.

As used herein, “modem” refers to a modem device, including one or more a cable modem (CM), a satellite modem, an optical network unit (ONU), a DSL unit, etc., which may be individually or collectively referred to as modems.

As used herein, the term “coherent transceiver,” unless specified otherwise, refers to a P2P or P2MP coherent optics transceiver having a coherent optics transmitting portion and a coherent optics receiving portion. In some instances, the transceiver may refer to a specific device under test (DUT) for several of the embodiments described herein.

As described herein, a “PON” generally refers to a passive optical network or system having components labeled according to known naming conventions of similar elements that are used in conventional PON systems. For example, an OLT may be implemented at an aggregation point, such as a headend/hub, and multiple ONUs may be disposed and operable at a plurality of end user, customer premises, or subscriber locations. Accordingly, an “uplink transmission” refers to an upstream transmission from an end user to a headend/hub, and a “downlink transmission” refers to a downstream transmission from a headend/hub to the end user, which may be presumed to be generally broadcasting continuously (unless in a power saving mode, or the like).

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, e.g., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “hyperscale” refers to a computing environment or infrastructure including multiple computing nodes, and having the capability to scale appropriately as increased demand is added to the system, i.e., seamlessly provision infrastructure components and/or add computational, networking, and storage resources to a given node or set of nodes. A hyperscale system, or “hyperscaler” may include hundreds of data centers or more, and may include distributed storage systems. A hyperscale system may utilize redundancy-based protection and/or erasure coding, and may be typically configured to increase background load proportional to an increase in cluster size. A hyperscale node may be a physical node or a virtual node, and multiple virtual nodes may be located on the same physical host. Hyperscale management may be hierarchical, and a “distance” between nodes may be physical or perceptual. A hyperscale datacenter may include several performance optimized datacenters (PODs), and each POD may include multiple racks and hundreds and thousands of compute and/or storage devices.

Exemplary CPON architectures, as well as the respective components thereof, are described in greater detail in U.S. Pat. Nos. 9,912,409, 10,200,123, and 10,523,356. Exemplary systems and methods for coherent burst reception are described in greater detail in co-pending U.S. patent application Ser. No. 17/401,473, filed Aug. 13, 2021, and U.S. patent application Ser. No. 17/346,940, filed Jun. 14, 2021. An exemplary rate-flexible CPON is described in co-pending U.S. patent application Ser. No. 18/905,880, filed Oct. 3, 2024. The disclosures of all of these prior patents and patent applications are incorporated by reference herein in their entireties.

In an exemplary embodiment, enhanced digital signal processing (DSP) algorithms advantageously utilize remote optical tone delivery to achieve a significantly lower-cost implementation of a 100G+ TFDM CPON having superior spectral efficiency in comparison with conventional techniques. The effectiveness of the present embodiments is demonstrated herein by experimental tests using a 50 km upstream burst transmission with a 32 split.

In an exemplary embodiment, an innovative architecture for a TFDM CPON is provided that enables replacement of relatively expensive external cavity lasers (ECLs) with significantly more affordable Fabry Perot laser diodes (FP-LDs) through novel optical injection locking (OIL) techniques. The experimental results described below further demonstrate no significant degradation in performance in comparison to conventional all-ECL-based systems. In an embodiment, frequency locking between the respective light sources of an optical line terminal (OLT) and an optical network unit (ONU) mitigates random frequency drifts, while also greatly simplifying receiver DSP by removing the need for carrier frequency offset (CFO) compensation.

For ease of explanation, the following embodiments are described with respect to burst TFDM signals in the upstream ONU transmission(s). The person of ordinary skill in the art though, will appreciate that such exemplary transmission scenarios are provided by way of example, and are not intended to be limiting.

### Operating Principles

FIG. 1A is a schematic illustration depicting an exemplary CPON architecture 100. In the exemplary embodiment depicted in FIG. 1A, CPON architecture 100 includes a centralized optical line terminal (OLT) 102 in operable communication with a plurality (i.e., 1-N) of ONUs 104 over an optical distribution network (ODN) 106 branching to respective ONUs 104 through at least one splitter 108. For illustrative purposes, CPON architecture 100 is described with respect to an upstream OLT in communication with downstream ONUs; however, the person of ordinary skill in the art will understand that this topology is provided by way of example, and is not intended to be limiting. The principles described herein may be applicable to other types of optical transceivers (e.g., an MTS, modems, and/or customer premises equipment (CPE)) or CPON topologies without departing from the scope herein.

In an embodiment, OLT 102 may be located within a central office, a communications hub, or a headend of an optical link, and functions to convert standard signals from a service provider (not shown) to the various frequency, modulation formats, and framing used by CPON architecture 100. In some embodiments, ODN 106 may include one or more single mode fibers (SMF), and/or splitter 108 may include a passive splitter and/or a power splitter/combiner.

In the exemplary embodiment depicted in FIG. 1A, CPON architecture 100 represents a TFDM CPON featuring remote optical tone delivery and upstream burst signaling for 100G operation, and which demonstrates superior flexibility for bandwidth allocation in comparison with conventional techniques. In the exemplary embodiment, OLT 102 includes an OLT transmitter 110 and an OLT receiver 112, and each ONU 104 includes an ONU transmitter 114 and an ONU receiver 116. In this exemplary scenario, OLT transmitter 110 further includes an OLT OIL subsystem 118 and a coherent modulator 120, and each ONU receiver 116 further includes an ONU OIL subsystem 122 and a coherent receiver 124, such as an integrated coherent receiver (ICR).

In exemplary operation of CPON architecture 100, OLT transmitter 110 is configured to broadcast a downstream (DS) signal 126 to respective ONUs 104 (i.e., for coherent detection by ONU receiver 116) over ODC 106, and OLT receiver 112 is similarly configured to receive one or more upstream (US) signals 128 from ONUs 104 (i.e., from respective ONU transmitters 114). In this example, DS signal 126 is broadcast in continuous mode, and is illustrated to include two 50G DS TFDM subcarriers 130 (illustrated as DS CH1 and DS CH2 in FIG. 1A), each at 12.5 GBd dual polarization (DP)-quadrature phase shift keying (QPSK), and equally spaced about a first optical tone 132 centered at frequency f₁. In this example, DS TFDM subcarriers 130 are shown to have respective bandwidths less than or equal to 15 GHZ, and to be centered, respectively, at ±15 GHz from f₁. DS signal 126 further includes a second optical tone 134 centered at frequency f₂. In an embodiment, second optical tone 134 is sufficiently spaced, in the frequency domain, from first optical tone 132 such that second optical tone 134 does not overlap with either DS TFDM subcarrier 130. In an exemplary embodiment, f₁ and f₂ are spaced 100 GHz apart to align with the ITU DWDM frequency grid.

In further exemplary operation of CPON architecture 100, at ONU 104, ONU OIL subsystem 122 utilizes (a) first optical tone 132/frequency f₁ as a locking parent light source to generate a local oscillator (LO) signal enabling ICR 124 to detect DS signal 126, and (b) second optical tone 134/frequency f₂ as a locking parent light source for ONU transmitter 114 to generate optical carriers for transmission as or in US signal 128. In this example, US signal 128 includes four 25G US TFDM subcarriers 136 (illustrated as US CH1-CH4 in FIG. 1A), each at 6.25 GBd DP-QPSK. In an exemplary embodiment, US TFDM subcarriers 136 are transmitted in TDM burst mode, and OLT receiver 112 is configured for burst reception of a respective burst distribution 138 for each US TFDM subcarriers 136 (described further below with respect to FIG. 1B). In this example, DS TFDM subcarriers 130 are shown to have respective bandwidths less than or equal to 10 GHz, and to be distributed about f₂ such that CH1 and CH4 are centered ±15 GHz from f₂ and CH2 and CH3 are centered ±5 GHz from f₂.

The person of ordinary skill in the art will appreciate that the particular 100G scenario depicted in FIG. 1A is provided by way of example, and is not intended to be limiting. For example, the principles described herein are applicable to a CPON operating at greater (or less) than 100G. Additionally, more or fewer DS TFDM subcarriers 130, US TFDM subcarriers 136, and/or optical tones 132, 134 may be utilized without departing from the scope herein. Additionally, DS TFDM subcarriers 130 and US TFDM subcarriers 136 are depicted in FIG. 1A as having equally-sized (i.e., 50G and 25G, respectively) carrier signals; this depiction is for ease of explanation. The person of ordinary skill in the art is apprised that the principles of the present embodiments are also applicable to DS signals and US signals having respective TFDM subcarriers of different sizes (e.g., 75G and 25G, etc.).

Through the innovative optical tone/subcarrier distribution scheme shown in FIG. 1A, CPON architecture 100 nearly doubles the spectral efficiency of single-fiber optical networks utilizing dual-comb techniques, while also eliminating the associated hardware cost to implement the dual combs. In comparison with dual-fiber optical networks (e.g., one fiber dedicated for DS transmission and another fiber dedicated for US transmission), systems and methods according to CPON architecture 100 nearly quadruple the spectral efficiency, while also doubling the available fibers needed for bidirectional transmission. In an exemplary embodiment, implementation of OLT and ONU OIL subsystems 118, 122 sufficiently amplifies both optical tones 132 and 134, such that the need for additional optical amplifiers therefor is eliminated thereby further reducing the necessary hardware cost of CPON architecture 100 in comparison with conventional systems.

FIG. 1B is a schematic illustration depicting an exemplary subcarrier distribution scheme for US burst distribution 138, FIG. 1A. More particularly, according to CPON architecture 100, distinct frequency bands of US TFDM subcarriers 136 may be designated based on the unique latency (e.g., regular channel or low-latency channel) or capacity requirements of a particular service or ONU 104. In the exemplary embodiment depicted in FIG. 1B, TFDM operation with burst transmission enables two-dimensional (i.e., time and frequency dimensions, in this example) bandwidth resource allocation and dynamic configuration of consecutive bursts in each TFDM subcarrier 136 to minimize latency. According to CPON architecture 100, multiple ONUs 104 may utilize a single subcarrier 136 for transmission to OLT 102.

The person of ordinary skill in the art will understand that this particular subcarrier distribution scheme is provided by way of example, and is not intended to be limiting. The advantageous techniques of CPON architecture 100 enable significant flexibility for digital subcarrier management from OLT transmitter 110 in consideration of various parameters or requirements of ONUs 104, considered either individually or together.

In an exemplary embodiment, OLT transmitter 110 further includes or is in operable communication with a transmitter DSP 140, and ONU receiver 124 further includes or is in operable communication with a receiver DSP 142. Exemplary processing techniques for transmitter DSP 140 and receiver DSP 142 are described further below with respect to FIGS. 2-4.

FIG. 2 is a schematic illustration depicting an exemplary logical transmission processing architecture 200. In an exemplary embodiment, logical transmission processing architecture 200 is executed with respect to transmitter DSP 140, FIG. 1A. In other embodiments, logical transmission processing architecture 200 may be executed with respect to a DSP (not separately shown) for ONU transmitter 114, FIG. 1A. Accordingly, in the exemplary embodiment depicted in FIG. 2, an input digital data signal 202 is converted, by a serial-to-parallel converter 204, into a plurality of separated data signals corresponding to the several subchannels of the respective US signal (e.g., TFDM subcarriers 136 of US signal 128, FIG. 1A) or DS signal (e.g., DS TFDM subcarriers 130 of DS signal 126, FIG. 1A).

In the case of US transmission (e.g., from ONU transmitter 114, FIG. 1A), the plurality of separated data signals are initially processed by a burst generation unit 206. In contrast, in the case of DS transmission (e.g., by OLT transmitter 110, FIG. 1A), the plurality of separated data signals may instead be initially processed by a subchannel processor 208 (e.g., transmitter DSP 140, FIG. 1A). That is, burst generation unit 206 is unnecessary for a continuous mode transmission. In the case where transmission processing architecture 200 is implemented for a US burst transmission, burst generation unit 206 may further include one or more of a guard band generation module 210, a receiver settling pattern generation module 212, a synchronization pattern generation module 214, a payload generation module 216, and a frame assembly module 218.

In further exemplary operation of transmission processing architecture 200, the plurality of separated data signals from serial-to-parallel converter 204, or plurality of assembled burst frames from burst generation unit 206 in the case of US transmission, are separately processed by subchannel processor 208. Subchannel processor 208 may, for example, further include one or more of a channel configuration module 220, a subchannel configuration module 222, a subchannel modulation module 224, a pulse shaping module 226, and a digital up-converter 228. The separate digitally up-converted data signals from subchannel processor 208 are then combined by a channel combination unit 230.

The combined data signal from channel combination unit 230 is then converted into an analog signal by a digital-to-analog converter (DAC) 232, and the analog signals therefrom are then fed to a transmitter 234 (e.g., OLT transmitter 110 or ONU transmitter 114, FIG. 1A) for transmission as a combined output optical signal 236. In an exemplary embodiment, subchannel processor 208 is further configured to assign respective burst frames (e.g., for US burst transmission) or data frames (e.g., for DS continuous transmission) to each subcarrier (e.g., US TFDM subcarriers 136 or DS TFDM subcarriers 130, respectively) after Nyquist pulse shaping by pulse shaping module 226 and digital up-conversion by digital up-converter 228.

FIG. 3 is a schematic illustration depicting an exemplary logical reception processing architecture 300. In an exemplary embodiment, logical reception processing architecture 300 is executed with respect to receiver DSP 142, FIG. 1A, such as in the case of a DS continuous transmission (e.g., DS signal 126, FIG. 1A). In other embodiments, logical reception processing architecture 300 may be executed with respect to a DSP (not separately shown) for OLT receiver 112, FIG. 1A, such as in the case of a US burst transmission (e.g., US signal 128, FIG. 1A).

In the exemplary embodiment depicted in FIG. 3, a receiver 302 (e.g., ICR 124 or OLT receiver 112, FIG. 1A) is configured to detect an input analog optical signal 304 (e.g., DS signal 126 or US signal 128, respectively, FIG. 1A) and a light source from an LO 306 (e.g., a DS LO signal injection-locked to f₁ of first optical tone 132, or a US LO signal injection-locked to f₂ of second optical tone 134, respectively, FIG. 1A). The received analog optical signals are then converted by an analog-to-digital converter (ADC) 308, and the resultant digital signals therefrom may then be separated into parallel data signals for processing by a subchannel processor 310 (e.g., receiver DSP 142, FIG. 1A). In an exemplary embodiment, the separate parallel data signals correspond, respectively, to separate subcarriers of received input analog optical signal 304 (e.g., TFDM subcarriers 136 of US signal 128 or DS TFDM subcarriers 130 of DS signal 126, FIG. 1A).

In an exemplary embodiment, subchannel processor 310 may include one or more of a digital down-converter 312, a fast Fourier transform (FFT) module 314, a digital filter 316, and an inverse FFT (IFFT) module 318 for separate processing of the parallel data signals. In the case of US reception (e.g., from ONU receiver 112, FIG. 1A), the plurality of processed data signals may be further processed for burst detection by a burst detection unit 320. Burst detection unit 320 may, for example, include one or more of a burst frame detection module 322, chromatic dispersion (CD) compensation module 324, a burst clock recovery module 326, a synchronization module 328, and a channel estimation module 330. In an embodiment, synchronization module 328 may be configured to implement a double-correlation based burst frame synchronization algorithm for reliable and robust burst detection.

In contrast, in the case of DS reception (e.g., by ONU ICR 124, FIG. 1A), the plurality of processed data signals may be instead fed directly from subchannel processor 310 to a subchannel signal recovery unit 322 configured to output a digital data signal 334.

FIG. 4 is a schematic illustration depicting an exemplary coherent burst frame logical architecture 400. More particularly, burst frame logical architecture 400 illustrates an exemplary configuration for preamble design of a coherent burst frame 402. In the exemplary embodiment depicted in FIG. 4, two successive burst frames 402 have respective frame lengths 404, and guard time slot 406 allocated therebetween along the time domain axis t. In an exemplary embodiment, architecture 400 is configured such that a transmitter turn-on time 408 and a transmitter turn-off time 410 occur within guard time slot 406, and each burst frame 402 includes a preamble portion 412 and a payload 414. Preamble portion 412 may further include a receiver settling section 416 and a synchronization section 418.

In an embodiment, receiver settling section 416 corresponds to a time duration where automatic gain control may be performed by a burst-mode transimpedance amplifier (BM-TIA) of an OLT (e.g., OLT 102, FIG. 1A). That is, receiver settling may occur after the BM-TIA has reached steady-state and an OLT receiver (e.g., OLT receiver 112, FIG. 1A) begins burst-mode signal processing for coherent detection of upstream burst signals (e.g., US signals 128, FIG. 1A). In comparison, synchronization section 418 is allocated for synchronization purposes, and may further include one or more of (i) a first subsection 420 dedicated for frame synchronization, (ii) a second subsection 422 dedicated for state-of-polarization (SoP) estimation, and (iii) a third subsection 424 dedicated for FOE.

### Experimental Demonstrations

To demonstrate utility of CPON architecture 100, FIG. 1A, an experimental setup was deployed to demonstrate the effectiveness of the TFDM CPON principles described herein.

FIG. 5 is a schematic illustration of an exemplary test architecture 500 for verifying experimental results of the embodiments herein. Test architecture 500 included an OLT 502 in communication with an ONU 504 over an ODC 506. For this test case, ODC 506 included a 50 km optical fiber link and a 1×32 passive optical splitter (not separately numbered) enabling bidirectional transmission. OLT 502 included a first ECL for generating DS TFDM signals through an OLT coherent driver modulator (CDM) 512 in communication with a DS subcarrier generator 514 (generating two respective subcarriers in this setup for DS CH1 and DS CH2, respectively), and a second ECL 510 for providing an LO signal to an OLT coherent receiver 516 for signal detection of a US burst signal 518 from ONU 504, which was received by OLT coherent receiver 516 from an OLT optical circulator 524 in connection with ODC 506 and after adjustment by a first variable optical amplifier (VOA) 526 disposed between OLT optical circulator 524 and OLT coherent receiver 516.

For test architecture 500, the outputs from first and second ECLs 508, 510 further functioned to provide parent optical tones (e.g., centered at frequencies f₁ and f₂, respectively) for enabling injection locking with first and second OIL subsystems of ONU 504. For this particular experimental test set up, the US signal 518 was measured and then processed using a first off-line DSP 528, and the measured results thereof are described further below with respect to FIG. 6B.

At the ONU end of test architecture 500, an ONU optical circulator 530 receives a DS TFDM signal 532, and then relays received DS TFDM signal 532 to a multiport tunable optical filter (TOF) 534 configured to separate the two DS TFDM subcarriers (similar to DS TFDM subcarriers 130, FIG. 1A) and the two optical tones disposed at frequencies f₁ and f₂. (similar to first and second optical tones 132, 134, respectively, FIG. 1A). The separated DS TFDM signals were then detected, after passing through a second VOA 536, at an ONU coherent homodyne receiver 538 using an LO light signal injection locked to frequency f₁ or f₂ by first OIL subsystem 520. For this test set up, TOF 534 was further configured to deliver the other of frequency f₁ and f₂ to second OIL subsystem 522, which was coupled to an ONU CDM 540 in communication with a US subcarrier generator 542 (generating four respective US subcarriers for in this setup for US CH1-CH4, respectively). For this setup, DS signal 532 was also measured and then processed using a second off-line DSP 544, and the measured results thereof are described further below with respect to FIG. 6A.

For the experimental setup of test architecture 500, off-the-shelf discrete components were used to conclusively demonstrate the effectiveness of the present systems and methods when using easily obtained and relatively less expensive discrete hardware. However, the person of ordinary skill in the art will be aware that the innovative systems and methods herein may readily utilize, without departing from the scope herein, advanced photonic integration platforms that are known to combine such otherwise separate components to achieve even further reduction in the CAPEX and/or OPEX of a CPON architecture implementing the present techniques.

In experimental operation of test architecture 500, DS signal 532 included two continuous wave (CW) TFDM subchannels, each at 12.5-GBd DP-QPSK. Similarly, US signal 518 included four burst TFDM subchannels, each at 6.25-GBd DP-QPSK. First OIL subsystem 520 thus serves to enable OIL for detection of DS signal 532, and second OIL subsystem 522 thus serves to enable OIL for generation of US signal 518. The person of ordinary skill in the art will appreciate that this implementation of OIL is provided by way of example, and is not intended to be limiting.

FIG. 6A is a graphical illustration depicting an optical spectrum plot 600 of DS signal 532, FIG. 5. More particularly, optical spectrum plot 600 illustrates the measured power of the combined DS signal including a first optical tone (e.g., first optical tone 132, FIG. 1A) provided by first ECL 508 centered at 191.7 THz (i.e., f₁), a second optical tone (e.g., second optical tone 134, FIG. 1A) provided by second ECL 510 centered at 191.6 THz (i.e., f₂), and two DS subcarriers (e.g., DS TFDM subcarriers 130, FIG. 1A) for DS CH1 and DS CH2 disposed about the first optical tone in the frequency domain.

FIG. 6B is a graphical illustration depicting an optical spectrum plot 602 of US signal 518, FIG. 5. More particularly, optical spectrum plot 602 illustrates the measured power of the combined US signal including four US subcarriers (e.g., US TFDM subcarriers 136, FIG. 1A) for US CH1-CH4 disposed about frequency f₂. As further illustrated in FIG. 6B, each US subcarrier includes a plurality of burst frames 604 carrying the respective US data information to OLT coherent receiver 516.

### Test Results

To further demonstrate the system functionality and performance of CPON architecture 500 with remote optical carrier delivery, further bi-directional transmission measurements were performed over the 50 km/32 split of ODN 506.

For these test results, architecture 500 was configured to execute DS transmission in continuous mode, and first OIL subsystem 520 of ONU 504 included an FP-LD (not separately shown) injection locked to frequency f₂ for use as the LO signal for ONU coherent homodyne receiver 538. As described further below with respect to FIGS. 7A-9B, the innovative OIL FB-LD-based configurations of the present embodiments demonstrated overall system performance comparable to ECL-based system, but at a significantly lower cost to utilize FP-LD light sources in the ONU (as well as the OLT receiver) instead of ECLs. These system-wide cost reductions are more dramatic when considering the CPON in a P2MP topology, where a single OLT may receive US signals from hundreds of ONUs.

For the several test results of architecture 500 described below, different symbol lengths were tested for burst synchronization in the US transmission using TFDM burst signals. Double-correlation patterns were selected with symbol lengths of 256, 128, 64, 32, and 16, corresponding to time periods of 40.96 ns, 20.48 ns, 10.24 ns, 5.12 ns, and 2.56 ns, respectively. For these test results, burst detection was most reliably achieved using symbol lengths larger than 32 (i.e., 5.12 ns). Additionally, a synchronization pattern of 256 symbols (40.96 ns) and an Rx setting pattern of 512 symbols (81.92 ns) were configured for the experimental US TFDM burst signals.

FIGS. 7A-B are graphical illustrations depicting measurement result plots 700, 702, respectively, obtained for DS signal 532, FIG. 5. More particularly, measurement result plot 700 shows the bit-error-rate (BER) versus received optical power (ROP) results for the continuous DS TFDM signals of DS CH1, and measurement result plot 702 shows the BER versus ROP results for the continuous DS TFDM signals of DS CH2. For comparative purposes, both of measurement result plots 700, 702 superimpose results for the 50 km/32 split fiber transmission configuration of ODC 506 with a back-to-back (B2B) configuration, and additionally, each fiber/B2B configuration using the OIL-based LO (e.g., first OIL subsystem 520, FIG. 5) for downstream signal detection against a conventional ECL source as the LO for downstream signal detection. As may be seen from measurement result plots 700, 702, implementation of the present OIL-based LO techniques demonstrates a fairly negligible difference in performance for the DS TFDM subchannels when compared with conventional ECL-based detection.

FIGS. 8A-D are graphical illustrations depicting measurement result plots 800, 802, 804, 806, respectively, obtained for US signal 518, FIG. 5. More particularly, measurement result plot 800 shows the BER versus ROP results for the US burst TFDM signals of US CH1, measurement result plot 802 shows the BER versus ROP results for the US burst TFDM signals of US CH2, measurement result plot 804 shows the BER versus ROP results for the US burst TFDM signals of US CH3, and measurement result plot 806 shows the BER versus ROP results for the US burst TFDM signals of US CH4. Similar to measurement result plots 700-702, FIG. 7, each of measurement result plots 800-806 also demonstrate comparative results for the same 50 km/32 split fiber and B2B transmission configuration of ODC 506, as well as the BER performance of each respective subcarrier in both configurations using (a) an FP-LD (not shown) in second OIL subsystem 522 as the transmission laser source, and (b) a conventional ECL as the transmission laser source, for comparative purposes.

Similar to the DS broadcasting results described above with respect to FIGS. 7A-B, US burst transmissions using the present OIL-based transmission techniques also exhibits negligible performance degradation at both the staircase hard-decision (HD) forward error correction (FEC) threshold (i.e., BER=4.5E−3), and at the concatenated soft decision (SD) FEC threshold (i.e., BER=1.2E−2), when compared with the conventional ECL-based transmission technique.

Accordingly, as shown in FIGS. 7A-8B, replacing a conventional ECL with the considerably less-expensive OIL-based transmission scheme of the present embodiments consistently demonstrates a negligible performance penalty in both the DS and US TFDM subchannels. The effect on carrier frequency offset (CFO) between these two transmission schemes is described further below with respect to FIGS. 9A-B.

FIG. 9A is a graphical illustration depicting a comparative plot 900 of residual CFO. More particularly, comparative plot 900 includes (a) a first subplot 902 illustrating the residual CFO measured in the case of frequency locking the ONU transmitter (e.g., second OIL subsystem 522 and ONU CDM 540, FIG. 5) and the ONU receiver LO (e.g., first OIL subsystem 520, FIG. 5) to the OLT light sources (e.g., f₁ and f₂), and (b) a second subplot 904 illustrating the residual CFO measured using conventional ECLs for the ONU transmitter and receiver LO. As shown in first subplot 902, the present OIL-based transmission techniques result in a residual CFO of approximately 0.12 MHz thus demonstrating relatively minimal optical frequency offset between the OLT and ONU by injection locking the light sources thereof. In contrast, second subplot 904 shows that the conventional ECL-based system results in a considerably larger CFO of approximately 0.34 GHz, thereby making signal recovery relatively impossible without significant additional CFO compensation.

Accordingly, comparative plot 900 thus demonstrates that systems and methods implementing the present OIL-based transmission techniques enable significant simplification of the DSP for a coherent receiver by removing the need for CFO compensation, thereby reducing the processing burden of each respective receiver in the CPON, which will further reduce the OPEX thereof.

FIG. 9B is a graphical illustration depicting a comparative plot 906 of BER versus ROP in consideration of CFO. More particularly, comparative plot 906 shows BER measurement results of both the DS signal and the US signal and for different case scenarios utilizing (a) the present OIL-based transmission techniques without additional CFO correction, and (b) a conventional ECL-based transmission implementing conventional CFO correction in the receiver DSP. As may be seen from comparative plot 906, the present OIL-based transmission techniques for a CPON demonstrate nearly identical performance to the conventional ECL-based transmission techniques, but without any of the additional CFO compensation required by the conventional ECL-based systems. In other words, the present OIL-based CPON systems and methods offer performance comparable to the more expensive ECL-based CPON, but without any need for the additional CFO compensation processing resources required by the ECL-based CPON.

Accordingly, when compared with conventional ECL-based CPON systems that require CFO compensation, the present systems and methods not only significantly reduce the ONU hardware cost by replacing each ECL with a considerably less-expensive FP-LD, the present systems and methods still further reduce the operating cost of the present CPON by enabling significant simplification to the complexity of the receiver DSP, thereby freeing considerable processing resources for the CPON operation.

FIG. 10 is a graphical illustration depicting a measurement plot 1000 of BER versus carrier power at a receiver. More particularly, measurement plot 1000 shows the TFDM signal performance over range of carrier power for the respective optical tone between two TFDM channels (e.g., DS CH1 and DS CH2 in the DS signal, US CH1-CH4 in the US signal). As shown by measurement plot 1000, the presence of an optical tone between two TFDM channels, according to the systems and methods described herein, does not significantly affect the TFDM signal performance where the carrier power of the optical tone is below −25 dBm at the receiver. For the results shown in measurement plot 1000, the carrier power level of the respective TFDM signals was approximately −40 dBm. Accordingly, measurement plot 1000 demonstrates how the present CPON systems and methods may achieved still further cost reduction by removing the need for optical filtering of the DS signal when the carrier power of the optical tone(s) are kept below −25 dBm.

As described herein, experimental demonstrations prove the effectiveness of remote optical carrier delivery to an ONU in a 100G TFDM CPON, particularly in the case of a significantly more inexpensive OIL-based transmission scheme for downstream continuous transmission from the OLT and upstream burst transmissions from the ONU(s). In comparison with a conventional ECL-based system, the present embodiments further demonstrate comparable results with respect to performance, and superior results with respect to random frequency drift that is significantly mitigated using injection-locked light sources (e.g., FP-LDs) instead of independently operated lasers (e.g., ECLs). According to the present embodiments, a significantly less-expensive solution is provided that utilizes low-cost laser sources at customer premises (e.g., ONUs, CPEs, etc.) in the NG CPONs.

The embodiments herein thus provide an innovative TFDM CPON architecture that Features advantageous solutions for both the hardware cost of primary system elements, as well as the operating resource cost through DSP simplification. These cost-effective solutions are achieved by implementing the remote parent optical tone delivery and OIL techniques described herein. Measurement results for US TFDM burst transmissions demonstrate nearly identical performance in comparison with conventional (and considerably more expensive) ECL-based CPON systems. The present OIL-based CPON though, demonstrates superior results over the ECL-based CPON with respect to CFO. By frequency-locking the respective OLT and ONU light sources, systems and methods according to the present embodiments enable removal of the CFO compensation process from the DSP coherent receiver without compromising system performance.

Exemplary embodiments of OIL-based CPON architectures and processing techniques are described above in detail. The systems and methods of this disclosure though, are not limited to only the specific embodiments described herein, but rather, the components and/or steps of their implementation may be utilized independently and separately from other components and/or steps described herein. Additionally, the exemplary embodiments can be implemented and utilized in connection with other access networks utilizing fiber and coaxial transmission at the end user stage.

As described above, the DOCSIS protocol may be substituted with, or further include protocols such as EPON, RFoG, GPON, Satellite Internet Protocol, without departing from the scope of the embodiments herein. The present embodiments are therefore particularly useful for communication systems implementing a DOCSIS protocol, and may be advantageously configured for use in existing 4G and 5G networks, and also for new radio (NR), 5G-NR, 6G, and future generation network implementations.

Although specific features of various embodiments of the disclosure may be shown in some drawings and not in others, such illustrative techniques are for convenience only. In accordance with the principles of the disclosure, a particular feature shown in a drawing may be referenced and/or claimed in combination with features of the other drawings.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processor (DSP) device, and/or any other circuit or processor capable of executing the functions described herein. The processes described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term “processor.”

This written description uses examples to disclose the embodiments, including the best mode, and also enables a person skilled in the art to practice the embodiments, including the make and use of any devices or systems and the performance of any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An optical network communication system utilizing a coherent passive optical network (CPON), comprising:
an optical line terminal (OLT) including:
(a) an OLT transmitter configured to transmit a downstream optical signal including (i) a first optical tone centered at a first frequency, (ii) a second optical tone centered at a second frequency different from the first frequency, and (iii) first and second downstream subcarriers distributed proximate the first frequency; and
(b) an OLT receiver configured to detect an upstream optical signal including first and second upstream subcarriers distributed proximate the second frequency;
an optical distribution network (ODN) in operable communication with the OLT and configured to transport the downstream and upstream optical signals therethrough; and
a first optical network unit (ONU) in operable communication with the ODN, and including:
(a) a first ONU receiver configured to detect the first and second downstream subcarriers using the first optical tone to generate a local oscillator (LO) signal for coherent detection; and
(b) a first ONU transmitter configured to generate the first and second upstream subcarriers using the second optical tone,
wherein the first and second optical tones, the first and second downstream subcarriers, and the first and second upstream subcarriers do not overlap in the frequency domain.

2. The communication system of claim 1, wherein the first and second downstream subcarriers and the first and second upstream subcarriers utilize time and frequency division multiplexing (TFDM).

3. The communication system of claim 2, wherein the OLT transmitter is further configured to transmit the first and second downstream subcarriers as continuous wave (CW) TFDM signals.

4. The communication system of claim 2, wherein the ONU transmitter is further configured to transmit the first and second upstream subcarriers as burst TFDM subcarriers.

5. The communication system of claim 1, configured for 100 Gb/s (100G) operation.

6. The communication system of claim 5, wherein each of the first and second downstream subcarriers are configured to run at 50 Gb/s (50G).

7. The communication system of claim 6, wherein the first and second frequencies are spaced at least 100 GHz apart, and wherein the first and second downstream subcarriers each span a frequency bandwidth less than 15 GHz.

8. The communication system of claim 7, wherein the first downstream subcarrier is centered 15 GHz less than the first frequency, and wherein the second downstream subcarrier is centered 15 GHz greater than the first frequency.

9. The communication system of claim 7, wherein each of the first and second downstream subcarriers is configured for operation as a 12.5 GBd dual polarization (DP)-quadrature phase shift keying (QPSK) signal (DP-QPSK).

10. The communication system of claim 5, wherein the upstream optical signal further includes third and fourth upstream subcarriers distributed proximate the second frequency, and wherein each of the first, second, third, and fourth upstream subcarriers are configured to run at 25 Gb/s (25G).

11. The communication system of claim 10, wherein the first and second frequencies are spaced at least 100 GHz apart, and wherein the first, second, third, and fourth upstream subcarriers each span a frequency bandwidth less than 10 GHz.

12. The communication system of claim 11, wherein the first upstream subcarrier is centered 15 GHz less than the second frequency, wherein the second upstream subcarrier is centered 5 GHz less than the second frequency, wherein the third upstream subcarrier is centered 5 GHz greater than the second frequency, and wherein the fourth upstream subcarrier is centered 15 GHz greater than the second frequency.

13. The communication system of claim 11, wherein each of the first, second, third, and fourth upstream subcarriers is configured for operation as a 6.25 GBd dual polarization (DP)-quadrature phase shift keying (QPSK) signal (DP-QPSK).

14. The communication system of claim 1, wherein the first ONU receiver includes a first optical injection locking (OIL) subsystem configured to injection lock the generated LO signal to the first frequency centering the first optical tone.

15. The communication system of claim 14, wherein the first ONU transmitter includes a second OIL subsystem configured to injection lock at least one optical carrier of the generated first and second upstream subcarriers to the second frequency centering the second optical tone.

16. The communication system of claim 14, wherein each of the first and second OIL subsystem includes at least one Fabry-Perot laser diode (FP-LD).

17. The communication system of claim 1, wherein the OLT further includes an OLT transmitter digital signal processor (DSP) and an OLT receiver DSP, and wherein the first ONU further includes a first ONU transmitter DSP and a first ONU receiver DSP.

18. The communication system of claim 1, further comprising a plurality of second ONUs (a) disposed remotely from the OLT, and (b) and configured for operable communication with the OLT over the ODN.

19. The communication system of claim 18, wherein the CPON is configured for point-to-multipoint (P2MP) operation.

20. The communication system of claim 18, wherein the plurality of second ONUs are configured to transmit within the upstream optical signal using time and frequency division multiplexing (TFDM).
